(19) United States
(12) Patent Application Publication
(10) Pub. No.: US 2017/0272664 A1
(43) Pub. Date: Sep. 21, 2017

(54) Visual System For A Vehicle, In Particular Commercial Vehicle

(71) Applicants: Werner LANG, Ergersheim (DE); Stefan SCHINZER, Geseke (DE)

(72) Inventors: Werner LANG, Ergersheim (DE); Stefan SCHINZER, Geseke (DE)

(21) Appl. No.: 15/460,941

(22) Filed: Mar. 16, 2017

(30) Foreign Application Priority Data
Mar. 16, 2016 (DE) 102016003233.2

(51) Int. Cl. H04N 5/272; B60R 1/12; H04N 5/232

(52) U.S. Cl. CPC H04N 5/272; H04N 5/23293; B60R 1/12; B60R 2001/1253; B60R 2300/105; B60R 2300/207; B60R 2300/302; B60R 2300/8046

(57) ABSTRACT

A visual system (1) for a vehicle (7) having a capturing unit (2) for capturing a field of view (8) and a calculation unit (3), which is adapted to generate image data to be displayed based on the captured image data, and to supply the same to an image display unit (4), wherein the image data to be displayed include the field of view (8) captured by the capturing unit (2), the image display unit (4) is adapted to display the image data to be displayed, so that they are visible for the driver of the vehicle (7), and the calculation unit (3) is adapted to superimpose at least one trajectory (10, 10′) of a future track/driving curve of the vehicle (7) on the image data to be displayed on the image display unit (4), if a steering angle of the vehicle (7) has a predetermined amount.

### BACKGROUND OF THE INVENTION

1. Field of the Invention

The invention relates to a viewing system, respectively a visual system for a vehicle, in particular commercial vehicle, by means of which visual system images of the vehicle environment can be displayed together with information on a future vehicle route in the vehicle interior, e.g. a driver's compartment of a commercial vehicle, so that they are visible for a driver while driving.

Such visual systems serve, inter alia, as mirror substitute systems, or they are used in addition to the mirrors, in particular rear-view mirrors and exterior mirrors, of a vehicle, to display the situation around the vehicle in certain driving situations to the driver in an optimum ergonomic manner in order to provide a driver assistance during driving and/or forward respectively backward manoeuvring of the vehicle.

These visual systems thus contribute to improve traffic safety by supporting the vehicle driver in certain driving situations in order to prevent possible collisions with other objects on the road.

2. Description of the Related Art

Mirror substitute systems and other camera monitor systems or display devices for vehicles, respectively, are known in the art. DE 10 2010 026 222 A1, for example, describes a device for assisting a driver in driving and/or manoeuvring a vehicle, wherein a region behind a vehicle is captured and an landmark is optically displayed dependent on the captured surrounding areas. By superimposing the landmarks on images output by an image capturing unit, the vehicle driver may be assisted in backward manoeuvring of the vehicle in order to avoid the risk of collision with obstacles and other road users.

The driver assistance device described in DE 10 2010 026 222 A1 is, however, unsuitable for a vehicle comprising a tractor unit and a trailer. The above-mentioned known driver assistance device has the further disadvantage that the vehicle driver is irritated and unnecessarily distracted, as a plurality of static auxiliary lines and distance lines are superimposed as guidance/landmarks on an image showing the rear part of the vehicle.

### SUMMARY OF THE INVENTION

It is an object of the invention to provide a visual system for a vehicle, in particular commercial vehicle, which can reduce or eliminate such disturbing or confusing influences on the driver on the image to be displayed.

This object is solved by a visual system comprising the features of claim 1. Preferred embodiments are given in the dependent claims.

The invention is based on the idea to assist the vehicle driver in certain driving situations, e.g. during backward manoeuvring and reversing into a parking space, respectively, or when driving along curves, by superimposing respectively inserting at least one trajectory (path) of a future vehicle route on an image showing a field of view of the vehicle environment, which image is displayed visible for the vehicle driver on an image display unit, only in case that a steering angle of the vehicle has a predetermined amount/value.

According to the invention, the term “vehicle” comprises a passenger car, a truck with a cargo space, as well as a truck with a trailer or semitrailer comprising a tractor (tractor unit) and a rearward extending portion, as well as vans (LCVs) of all types, construction machines, agricultural vehicles, etc. Trailers according to the invention may comprise one or plural axes, wherein the axes may be rigid and/or pivotable.

According to the invention, the tractor pulls the trailer during forward driving and pushes the trailer during reversing (backward driving). Thus, the tractor according to the invention may be generally referred to as drive unit for pulling or pushing objects.

According to the invention, the predetermined amount/value of the steering angle is larger than 0 degrees and, preferably, is in the range between 5 to 90 degrees. Here, the steering angle defines, for example, a turning of the wheels of the front axis with respect to the longitudinal axis of the vehicle and the tractor, respectively. The wheels may be turned to the left or to the right with regard to the longitudinal axis. According to the present invention, the steering angle is adjusted by turning the steering wheel in the driver cabin of the vehicle and de-pends on several factors like, for example, vehicle loading and various other tensions (twisting) when transferring the rotation of a steering wheel to the wheels. Consequently, the turning angle of the steering wheel does not exactly correspond to the actual steering angle.

Depending on the vehicle geometry, e.g. depending on whether the vehicle is a simple truck or a combination of truck and trailer and semitrailer, respectively, the above-mentioned steering-angle range may deviate accordingly.

By superimposing at least one trajectory on an image showing the environmental area of the vehicle when the steering angle has the predetermined amount/value, it is prevented that the vehicle driver is unnecessarily confused by a permanent superimposition of the trajectory, i.e. also in case where such superimposition is not necessary due to the driving situation.

According to the invention, a calculation unit (processing unit) calculates the at least one trajectory by means of at least one vehicle-related input, which is processed in a mathematical model. A vehicle parameter of this kind is, for example, the steering angle, wheel-sensor in-formation, etc. Inputs of the mathematical model are, for example, steering angle, vehicle speed, driving direction, ABS wheel signals, etc., wherein at least one of these inputs, prefer-ably at least two of these inputs are used.

According to a further development of the invention, the capturing unit for capturing a field of view is configured such that the captured field of view extends, at least partly, laterally next to the vehicle and beyond a length of the vehicle. A capturing unit of this type is, for example, used in a mirror substitute system.

Alternatively, a plurality of capturing units may be provided, wherein such capturing unit may be, for example, a camera or an image sensor.

According to the invention, the capturing unit captures the lateral and rear lateral area of the vehicle, but a part of the vehicle and the vehicle geometry, respectively, is not included in the captured field of view. In this case, a virtual vehicle reference may be superimposed on the display unit, indicating, for example, how far the vehicle is outside the field of view, i.e. a measure of distance between a lateral surface of the vehicle and the edge of the field of view facing the vehicle.

According to the invention, the capturing unit is arranged such that it is directed to the rear and/or to the front and/or to the side with regard to the forward-driving direction of the vehicle. The display on the image display unit corresponds to this perspective and, thus, at least approximately corresponds to the view a driver has when looking in a conventional side mirror. The image display unit is, for example, a monitor, digital mirror, e.g. digital rear-view mirror or digital side mirror.

If the visual system is used as a mirror substitute system according to a preferred embodiment, it is further possible that the display on the image display unit is effected permanently and in real time, wherein the superimposition of at least one trajectory showing a future track of the vehicle is only displayed if the predetermined steering angle is present.

According to the invention, the calculation unit is also adapted to analyse image data captured by the capturing unit and to use predefined points on the vehicle as reference points for dis-playing the trajectory in an image showing a field of view that extends, at least partly, laterally next to the vehicle and beyond a length of the vehicle. The predefined point on the vehicle, which serves as reference point, is, for example, a vehicle edge, vehicle corner, vehicle axis and/or vehicle wheel.

This analysis may be effected by image analysis or by means of additional sensors, for example, distance sensor, radar, infrared sensor or the like, that are attached to (installed on) the vehicle and provide input (input signals) into the calculation unit.

The at least one trajectory may, for example, be superimposed only when the predetermined steering angle is present and the capturing unit captures an obstacle in the vehicle environment with which obstacle the vehicle will collide when maintaining steering angle and driving direction.

According to a further development of the invention, the vehicle comprises a tractor and a trailer that is pivotable with regard to the tractor. In the present invention, the term “trailer” also includes semitrailers.

According to the invention, in such a vehicle comprising tractor and trailer, the calculation unit is adapted to pre-calculate at least one first trajectory of the tractor unit and at least one second trajectory of the trailer for a future track (driving curve) of tractor unit and trailer, respectively.

In particular, a first trajectory for the tractor and a second trajectory for the trailer are dis-played on the image of the lateral and rear area (lateral rear area of the trailer) shown on the image display unit. The trajectory is, for example, represented by a line, which is curved/bent dependent on the steering angle, and which has a first colour for the tractor and a second colour for the trailer. It is also possible that the trajectory is not represented by a line but by an area, which is, for example a virtual guide area or guide rail for assisting the driver during driving along curves or manoeuvring.

As mentioned above, also in a vehicle comprising a tractor and a trailer, the first and second trajectory, respectively, is displayed when the steering angle of the tractor has a predetermined amount/value, in order to not unnecessarily confuse the driver during “normal” driving (i.e. during straight forward or rearward driving).

According to the invention, in a vehicle comprising a tractor and a trailer, the above-mentioned mathematical model may provide an angle formed between the tractor and the trailer as an output (output signal).

According to a further development of the invention, at least one predefined point on the vehicle is used as a reference point for representing a trajectory in an image displayed on the image display unit. This reference point may, for example, be the rear axis of the vehicle or, in case the vehicle comprises a tractor and a trailer, the rear axis of the tractor and/or the rear axis of the trailer. Alternatively, a loading edge of the vehicle may be used as the reference point that is used for representing the trajectory. Therefore, such reference point runs along such trajectory, for example during reverse driving. Other suitable reference point on the vehicle, e.g. corners or edges, may be used for representation of the trajectory.

Regarding the calculation unit, it has to be noted that the calculation unit may be provided as separate unit for the visual system, divided into a plurality of units, as integrated unit in an on-board computer (ECU) or the like.

According to the invention, superimposing the trajectory on the image, which represents the area laterally next to the vehicle and the lateral rear area of the vehicle, is effected in a trans-parent manner by means of a line and/or an area, wherein line and area can be suitably scaled and adapted to improve the display of a future track (driving curve) of the vehicle.

It is explicitly stated that the visual system according to the invention may also be used to superimpose one or more trajectories, as mentioned above, on an image showing the area later-ally next to and laterally behind the vehicle, independent of a predetermined steering angle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is exemplarily described with reference to the enclosed drawings, wherein same reference numbers denote same or corresponding components in the Figures. In the Figures:

FIG. 1 schematically shows a visual system according to an embodiment for a vehicle;

FIG. 2 shows a top view of a vehicle, which illustrates capturing areas (fields of view) of capturing units attached to the vehicle;

FIG. 3 shows a schematic illustration of a vehicle with the trajectory being illustrated;

FIG. 4 shows a top view of a vehicle comprising a tractor and trailer (semitrailer), which illustrates a lateral capturing area of a vehicle-mounted capturing unit;

FIG. 5 schematically shows an example of an image displayed on an image display unit;

FIG. 6 shows a top view of the vehicle according to FIG. 4 when driving along a curve;

FIG. 7 shows a schematic illustration of a further example of an image displayed on the display unit, for the driving situation illustrated in FIG. 6;

FIG. 8 shows a schematic illustration of a further example of an image displayed on the image display unit, for the driving situation illustrated in FIG. 6;

FIG. 9 shows a top view of a vehicle comprising a tractor and a trailer, which illustrates capturing areas of a vehicle-mounted capturing unit;

FIG. 10 shows a schematic illustration of an example of an image displayed on the image display unit, for the driving situation illustrated in FIG. 9;

FIG. 11 shows a top view of a vehicle comprising a tractor and a trailer, which illustrates capturing areas of a vehicle-mounted capturing unit;

FIG. 12 shows a schematic illustration of an example of an image displayed on the image display unit, for the driving situation illustrated in FIG. 11;

FIG. 13 shows a further example of an image that can be displayed on the image display unit; and

FIG. 14 shows a further example of an image that can be displayed on the image display unit.

### DETAILED DESCRIPTION OF THE PRESENTLY PREFERRED EMBODIMENTS

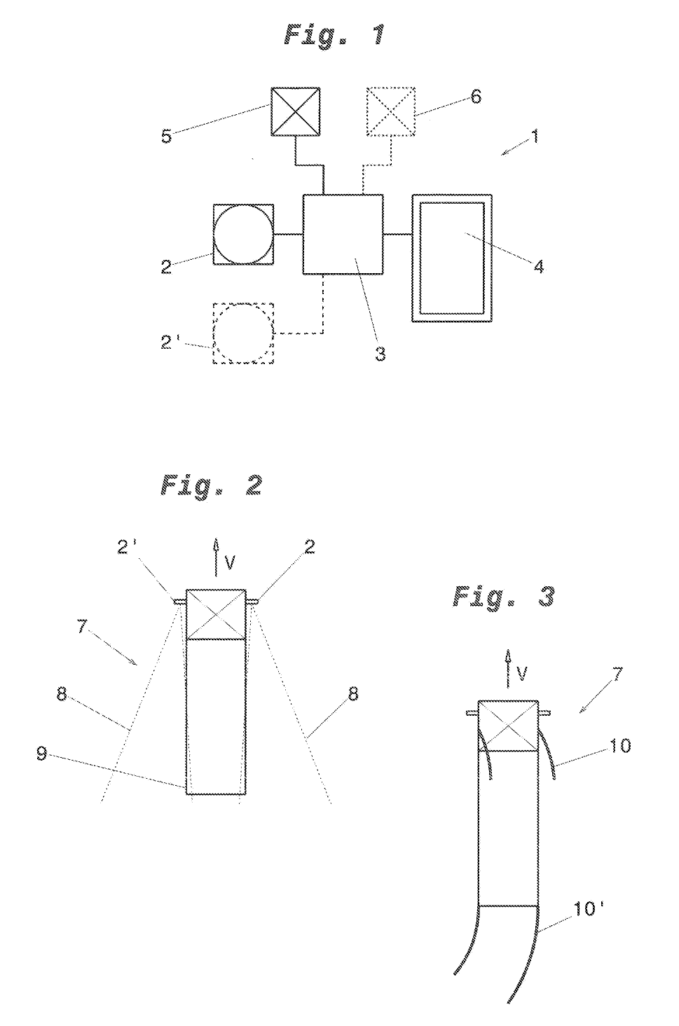

FIG. 1 schematically shows a visual system 1 according to an embodiment of the invention. The visual system comprises one or more capturing units 2, 2′, a calculation unit 3, and an image display unit 4. The capturing unit 2, 2′ may, for example, be a camera or an image sensor.

A first capturing unit 2, for example, captures an image that corresponds to that of a right side mirror, and a second capturing unit 2′ captures an image that corresponds to that of a left side mirror, and these images are displayed adjacent to one another, e.g. separated by separating lines, on the image display unit 4. Alternatively, it is also possible that a plurality of capturing units 2, 2′ provide a common image, i.e. that, by means of the calculation unit 3, the individual images captured by the capturing units 2, 2′ are combined (merged) into a common image, e.g. with seamless transitions, which common image is to be displayed on the image display unit.

The visual system as shown in FIG. 1 further comprises a unit 5, which provides an external input. The external unit 5 is connected to the calculation unit 3, so that the input provided by the unit 5 may be used by the calculation unit 3.

The visual system 1 as shown in FIG. 1 may also be connected to further vehicle sensors or the like. In FIG. 1, for example, a further unit 6 for vehicle sensors and/or environmental sensors is schematically provided. The sensor may be a steering-angle sensor, a speed sensor, a distance sensor or the like.

The calculation unit 3 for the visual system 1 as shown in FIG. 1 may be formed as a separate unit or, optionally, may be integrated in the image display unit 4, the capturing unit 2, 2′ or a not illustrated ECU of the vehicle.

The capturing unit 2 according to FIG. 1 captures images of the vehicle surroundings and, if necessary, part of the vehicle geometry, and supplies these image data to the calculation unit 3. In particular, the capturing unit 2, 2′ captures areas laterally next to the vehicle and laterally behind the vehicle. The calculation unit 3 comprises a mathematical model comprising at least two inputs (steering angle, speed, driving direction, yaw rate, ABS wheel signals, etc.) provided by the units 5, 6.

According to the preferred embodiment of the visual system 1 according to the invention as shown in FIG. 1, the visual system 1 is designed as a mirror substitute system, in particular for displaying an area laterally next to the vehicle and an area laterally behind the vehicle.

FIG. 2 schematically illustrates a top view of a vehicle 7 with possible viewing angles of capturing units 2, 2′ for a display (representation) corresponding to a right and a left side mirror of the vehicle 7. The capturing units 2, 2′ are mounted on the left and right, respectively, of the vehicle, which is a commercial vehicle without a trailer in this case, at the height of the driver's cabin.

Cones of view (fields of view or capturing ranges/areas) 8 of the capturing units′ 2, 2′ extend rearwards and laterally beside the vehicle 7 with regard to the forward driving direction V, as indicated in the top view of the vehicle 7 shown in FIG. 2. Accordingly, the cones of view 8 on the vehicle's 7 left side and right side, respectively, capture an area extending from the front to the rear (with regard to the forward driving direction V), thereby widening in the lateral direction, and, besides an area laterally next to the vehicle, also capture part of the vehicle geometry 9 and an area laterally behind the vehicle.

Alternatively, the cone of view 8 may be defined such that the vehicle geometry 9 is not captured. In this case, for example, the calculation unit 3 may calculate a distance between the vehicle geometry 9 and the cone of view 8 based on vehicle-related inputs, and suitably display this distance to the driver of the vehicle 7 on the image display unit 4.

FIG. 3 shows a top view of the vehicle 7 according to FIG. 2 with illustrated trajectory 10 for a front portion of the vehicle and a trajectory 10′ for a rear portion of the vehicle 7 during curve driving in driving direction V.

In particular, the vehicle 7 of FIG. 3 drives along a left turn in driving direction V, wherein the trajectory 10 illustrates a track/driving path of the front wheels, and the trajectory 10′ illustrates a track/driving path for the rear wheels. The trajectory 10 and 10′, respectively, is calculated by the calculation unit 3 of the visual system according to FIG. 1 and, for example, superimposed (inserted) on the image display unit 4. The trajectory 10 and 10′, respectively, may illustrate the actual track/driving path or, alternatively, a future track/driving path calculated by the calculation unit 3 dependent on a steering angle of the vehicle. For the sake of clear presentation, the trajectory 10 may be displayed in a first colour on the display unit 4, and the trajectory 10′ may be displayed in a second colour on the image display unit 4. Although, in FIG. 3, the trajectory 10, 10′ is illustrated as a line, it may alternatively be illustrated as a region or area.

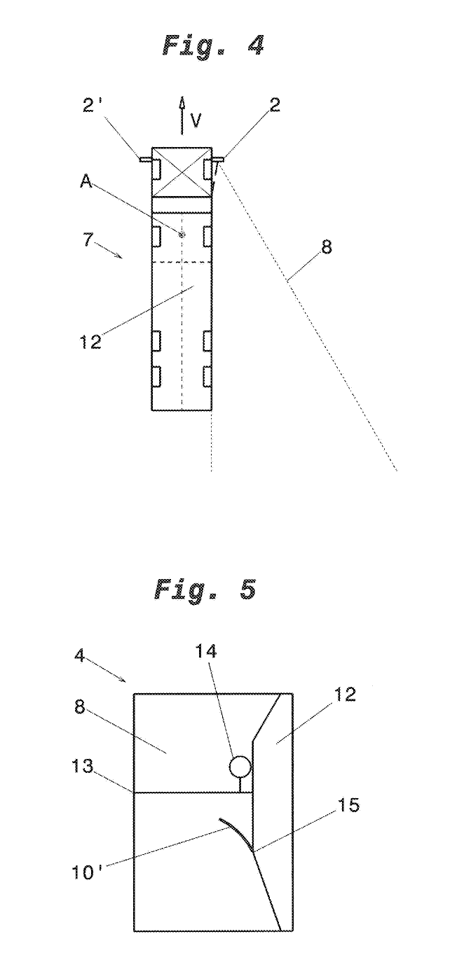

FIG. 4 shows a schematic top view of a vehicle 7 comprising a tractor 11 and a trailer 12. In particular, the trailer 12 is formed as a semitrailer, which is supported by the tractor and pivotable around the axis A with regard to the tractor 11.

As shown in FIG. 4, also in this vehicle 7, the capturing unit 2 captures an area laterally next to the vehicle, which extends to the lateral rear side of the vehicle. Although only the area laterally to the right of the vehicle 7 is captured in FIG. 4, it is clearly understood that also an area laterally to the left of the vehicle 7 can be captured in order to be displayed on the image display unit 4 according to the visual system of FIG. 1.

When using the visual system 1 according to the preferred embodiment as a mirror substitute system, in particular as side mirror, an image on the image display unit 4 showing the field of view 8 as shown in FIG. 5 is displayed to the driver of the tractor unit 11. The image shown in FIG. 5 roughly illustrates the driving situation shown in FIG. 3.

As shown in FIG. 5, the driver of the tractor 11 can see an image of the field of view 8 including a rear vehicle geometry 9 of the trailer 12 on the display unit 4. For clarification, FIG. 5 further shows a horizon 13 and a schematically illustrated tree 14.

In the visual system 1 according to the preferred embodiment, a trajectory 10′, similar to that of FIG. 3, is superimposed (inserted) on the image captured by the capturing unit 2 and having the field of view 8. A trajectory 10′ of the kind shown in FIG. 5 may indicate an actual track/driving path of the trailer 12 of FIG. 4. Alternatively, the trajectory 10′ of the trailer 12 may indicate a future track/driving path of the trailer 12, e.g. during manoeuvring when the vehicle 7 drives, for example, along a curve in the forward or reverse direction.

Here, the trajectory 10′ is calculated by the calculation unit 3 based on vehicle-related inputs and using, for example, the steering angle. The trajectory 10′ as shown in FIG. 5 may be illustrated only when the steering angle reaches a predefined amount/value, i.e. on strongly turning the steering wheel, so that the trailer 12 strongly pivots around the axis A with regard to the tractor 11.

According to a further embodiment, the trajectory 10′ may be calculated in real time and superimposed on the image captured by the capturing unit 2, 2′ during movement of the vehicle, independent of whether the steering angle has reached a predetermined amount (value).

As shown in FIG. 5, the trajectory 10′ extends from a rear left lower corner of the trailer 12 (the rear right corner when viewed from behind the vehicle) towards the horizon 13. According to this embodiment, the left lower corner 15 is a predefined point on the trailer 12, which is used as a reference point for illustrating the trajectory 10′. The left lower corner 15 of the trailer 12 thus runs along the trajectory 10′.

Instead of the left lower corner 15 of the trailer 12 as shown in FIG. 5, also a lower and/or upper edge and a lower and/or upper corner, respectively, of the trailer 12 may be chosen, from which a respective trajectory extends. In the case of an upper corner and edge, respectively, of the trailer 12, the driver of the vehicle 7 is, for example, assisted in assessing whether the trailer 12 may pass beneath an obstacle with regard to its height.

FIG. 6 shows a schematic top view of the vehicle 7 according to FIG. 4, where the trailer 12 is pivoted laterally to the right around the axis A with respect to the tractor 11. The degree of pivoting is, in particular, determined by a steering angle W of the vehicle 7. Such driving situation, as shown in FIG. 6, describes, for example, driving along a right turn.

As shown in FIG. 6, the field of view 8 captured by the capturing unit 2, is partly concealed by the vehicle geometry 9. For this reason, the driver of the tractor 11 cannot view the area concealed by the vehicle geometry 9, and this area cannot be captured by the capturing unit 2 and displayed on the image display unit 4. In order to assist the driver, the above-mentioned trajectory 10, 10′ is superimposed on the image displayed on the image display unit 4. According to this embodiment, as a predefined point on the vehicle, which serves as a reference point for illustrating the trajectory 10, 10′, the respective left and right lower corners of the tractor 11 are used for the trajectory 10, and the left and right lower corners of the trailer 12 are used for the trajectory 10′. Although not shown in FIG. 6, the capturing unit 2′ may correspondingly capture a field of view on the left side of the vehicle 7, and superimpose corresponding trajectories on a captured image of the lateral and lateral rear area of the vehicle 7.

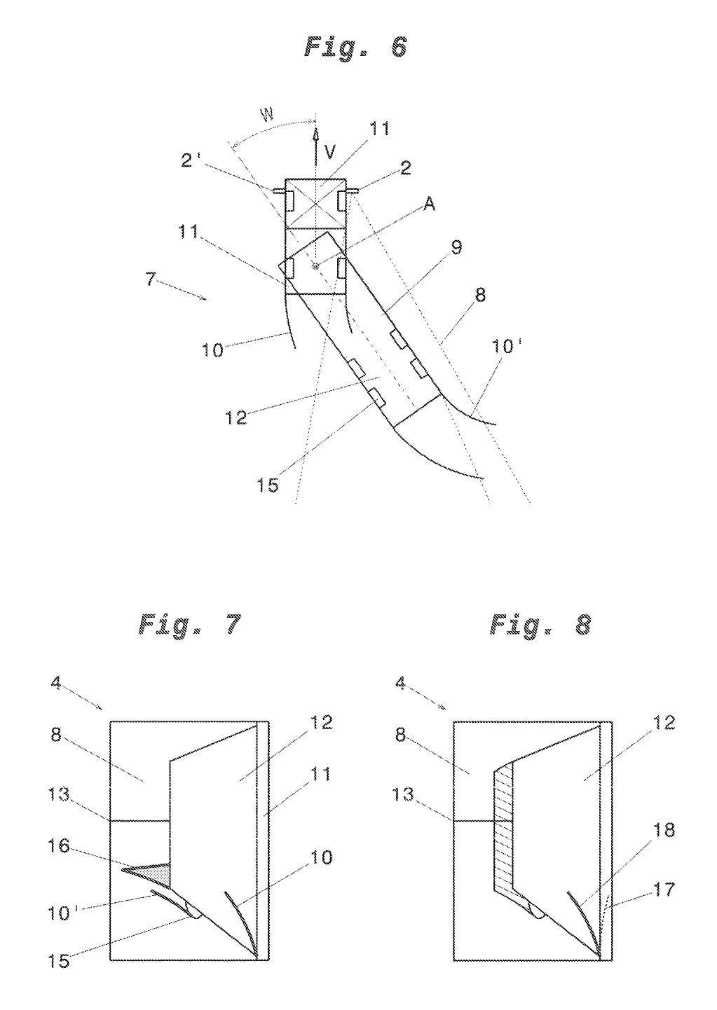

FIG. 7 shows a schematic illustration for an example of the display of an area laterally next to the trailer 12 and laterally behind the trailer 12, on which a trajectory 10, 10′ is superimposed to assist the driver of the tractor 11. According to this example, by means of the trajectory 10 and the trajectory 10′, the driver may view a future track/driving curve of the trailer 12 and the tractor unit 11, respectively, on the image of the trailer's 12 lateral and lateral rear area, respectively, which image is displayed on the image display unit 4. According to this example, e.g. during reversing, the trajectory 10 and 10′, respectively, is predicted dependent on a vehicle-related input, as mentioned above, and displayed. According to the example shown in FIG. 7, the rear axis 15 is used as a predefined point for the trailer, which point is used as a reference point for illustrating the trajectory 10′. In particular, the trajectory 10′ extends from a rear wheel of the trailer 12.

FIG. 7 further shows a loading edge 16, which may be used as an alternative reference point for illustrating the trajectory 10′. The trajectory 10 and 10′, respectively, may be superimposed on the image captured by the capturing unit 2 only in a predefined driving situation, e.g. reversing, and only if a predetermined turning angle of the steering wheel, which turning angle corresponds to a steering angle of the vehicle, is reached. A range for the steering angle is, for example, between 0 and 90 degrees, preferably between 5 and 90 degrees.

Alternatively, according to a further embodiment of the invention, the superimposition of the trajectory 10 and 10′, respectively, may be effected independent of a steering angle.

FIG. 8 shows a schematic illustration of an image displayed to a driver of the vehicle 7 on the image display unit 4. According to this embodiment for displaying the field of view 8 captured by the capturing unit 2, an actual trajectory 17 and a target trajectory 18 are displayed to the driver of the vehicle 7 by superimposition on the image having the field of view 8, which image is captured by the capturing unit 2. In this manner, the driver of the vehicle 7 may be assisted in manoeuvring, by changing the steering angle of the vehicle such that the actual trajectory 17 and the target trajectory 18 coincide, thus moving the trailer 12 into the area behind the trailer 12, which is illustrated by the hatched area in FIG. 8.

FIG. 9 shows a top view of a vehicle comprising a tractor 11 and a trailer 11, which is similar to that of FIGS. 4 and 6, with the difference that the trailer 12 of this embodiment is no semitrailer, but a separate trailer that is laterally pivotable around an axis A′ with regard to the tractor. In particular, the trailer 12 has two axes, wherein, viewed in a forward driving direction, the front axis is pivotable and the rear axis is rigid.

For a vehicle 7 as shown in FIG. 9, there is the danger that the tractor 11 collides with the trailer 12 at the point K in case of excessive steering (large steering angle W).

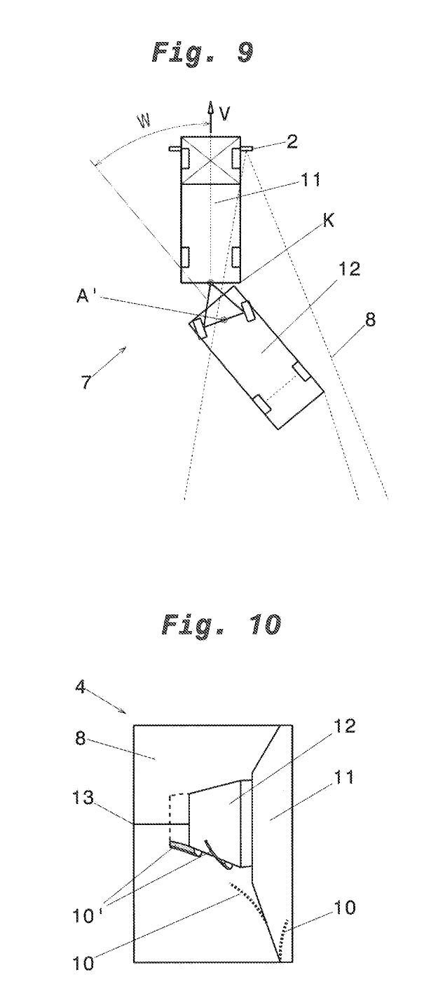

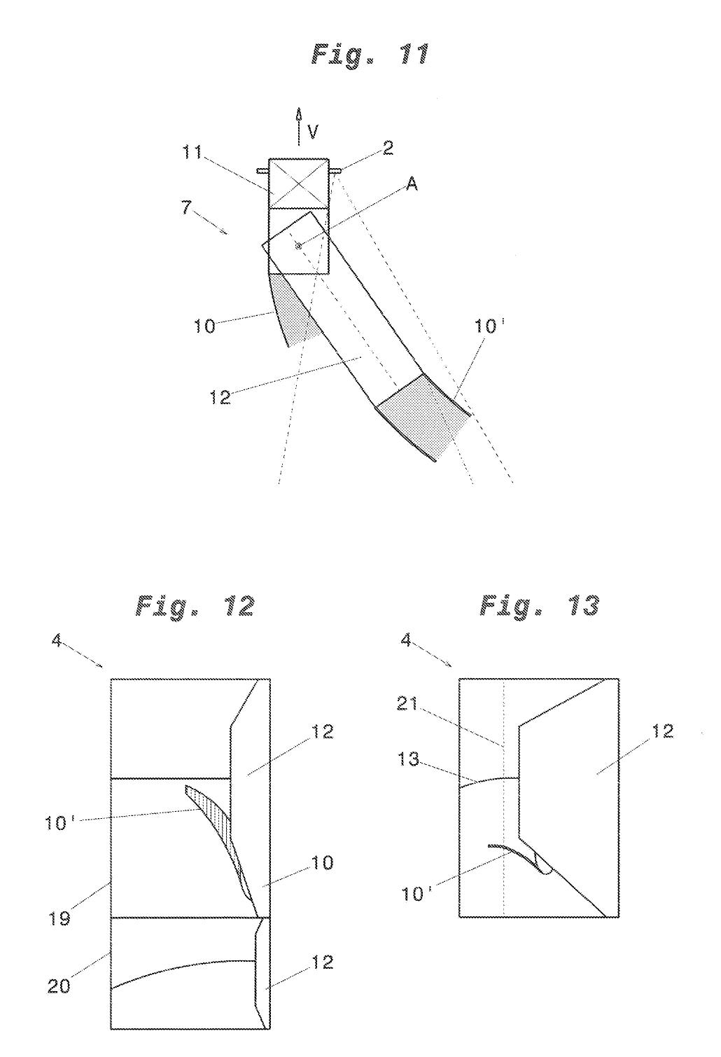

According to the visual system of the invention, the driver of the vehicle 7 may be assisted in avoiding such a collision by superimposing a plurality of trajectories in addition to the field of view 8 laterally right next to the vehicle 7, as shown in FIG. 10.

FIG. 10 shows an example for a display on the image display unit 4, which is displayed to the driver of the vehicle 7 according to FIG. 10, during driving along a curve.

In particular, in FIG. 10, two trajectories are superimposed for the tractor unit 11, wherein, for example, a left rear corner (right rear corner when viewed from behind the vehicle 7) of the tractor 11 is used as a reference point for the first trajectory 10, and a left front corner (right front corner when viewed from behind the vehicle 7) is used as a reference point for the second trajectory 10. The first and second trajectories 10 of the tractor unit 11 are illustrated by dotted lines in FIG. 10.

Due to the pivotable front axis of the trailer 12 of the vehicle 7 according to FIG. 9, FIG. 10 further shows two trajectories 10′ for the trailer 12, wherein the trajectory 10′, which extends from the pivotable front axis, has a different direction than the trajectory 10′, which extends from the rear axis of the trailer. In particular, FIG. 10 illustrates the trajectory 10′ extending from the rear axis of the trailer as an area and bold line, respectively.

FIG. 11 shows a schematic top view of a vehicle 7 having a tractor 11 and a trailer 12, similar to that of FIGS. 4 and 6, wherein the trajectory 10, 10′ is illustrated as an area.

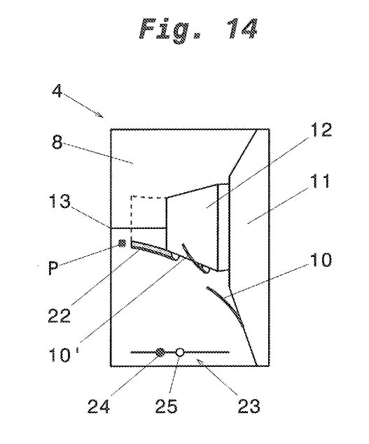

FIG. 12 shows a schematic illustration of an image displayed to the driver of the vehicle 7 on the image display unit 4, when the visual system 1 is used as a mirror substitute system for a main mirror and a wide-angle mirror 19, 20 of the vehicle 7.

On the display shown in FIG. 12, the image of the main mirror 19 is provided and arranged above the image of the wide-angle mirror 20 on the image display unit 4. Alternatively, as shown in FIG. 13, the image of the main mirror and the image of the wide-angle mirror 19, 20 may be arranged such by means of the calculation unit 3, that there is a seamless transition between them. A border line 21 between the two images, which border line is indicated in FIG. 13 by a dotted line, and beyond which line the display is compressed, does not necessarily have to be provided.

As shown in FIG. 12, the trajectory 10′ of the main mirror 19 does not have the form of a line in this embodiment, but indicates a region (area).

As shown in FIG. 13, due to the panoramic view, the trajectory 10′ of the trailer 12 is compressed starting at the dotted line 21.

FIG. 14 shows a further example of an image that may be displayed on the image display unit. Similar to FIG. 8, a target trajectory 22 is superimposed on this image. The target trajectory 22 may be adjusted by the driver of the vehicle 7 by turning the steering wheel such that a target point P is targeted. The target point P may, for example, be an entry or a parking space. When reaching the desired target trajectory 22, the driver may confirm the selected target trajectory 22, e.g. by operating a switch.

FIG. 14 further shows corresponding trajectories 10 and 10′ for the tractor 11 and the trailer 12, respectively, which correspondingly change dependent on the target trajectory 22 and indicate a future track/driving curve for the set target trajectory 22.

FIG. 14 further shows a display 23 in the form of a straight line, on which a first marking 24 and a second marking 25 are provided. The first marking 24 represents, for example, the destination location P and the second marking a current situation. The display 23 informs the driver of the vehicle 7 on the extent of deviation from the target point when a steering angle is maintained. In this manner, the driver of the vehicle 7 may readily achieve a correlation of the first and second marking by a corresponding steering wheel movement, thereby ensuring that the target point P is actually reached.

According to this embodiment, the first and second markings 24, 25 have a circular shape. Any other shapes, e.g. triangle, rectangle, line etc. may be chosen. If an identical form is chosen for the first and second markings 24, 25, the markings 24, 25 preferably have different colours or hatchings.

Although the invention has been described with reference to preferred embodiments and preferred displays of an image of a lateral and lateral rear area of a vehicle with superimposed trajectory in the above description, it is obvious that various modifications and changes may be made without exceeding the scope of the invention. For example, also the displays shown in FIGS. 3, 6, 9, and 11 may be additionally or alternatively displayed on the image display unit 4 in order to assist the driver during driving.

Although the trajectories are illustrated as lines or areas according to the above, any other forms of presentation are conceivable.

It is explicitly noted that a superimposition of a trajectory on an image captured by the image capturing unit does not only have to be effected in case of a predefined steering angle, but that a trajectory may also be superimposed as a standard and in real time, independent of a steering angle, i.e. over the entire driving time.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A visual system for a vehicle, comprising
a capturing unit for capturing a field of view;
an image display unit;
a calculation unit adapted to generate image data to be displayed based on the captured image data, and to supply the same to the image display unit, wherein the image data to be displayed include the field of view captured by the capturing unit,
wherein the image display unit is adapted to display the image data to be displayed such that they are visible for the driver of the vehicle, and
wherein calculation unit is adapted to superimpose at least one trajectory of a future track/driving curve of the vehicle on the image data to be displayed on the image display unit if a steering angle of the vehicle has a predetermined amount.

2. The visual system according to claim 1, wherein the calculation unit is adapted to calculate the at least one trajectory by means of at least one vehicle-related input.

3. The visual system according to claim 2, wherein the at least one vehicle-related input is processed in a mathematical model.

4. The visual system according to claim 3, wherein the mathematical model comprises at least two inputs.

5. The visual system according to claim 4, wherein the at least two inputs are selected from among a steering angle, driving speed, driving direction, yaw rate and/or ABS wheel signals of a steering axis of the vehicle.

6. The visual system according to claim 1, wherein the field of view captured by the capturing unit extends, at least partly, laterally next to the vehicle and beyond a length of the vehicle.

7. The visual system according to claim 1, wherein the at least one trajectory can be superimposed on the field of view captured by the capturing unit.

8. The visual system according to claim 1, wherein the vehicle comprises a tractor and a trailer that is pivotable with respect to the tractor.

9. The visual system according to claim 8, wherein the calculation unit is adapted to pre-calculate at least one first trajectory of the tractor and at least one second trajectory of the trailer for a future track/driving curve of tractor unit and trailer.

10. The visual system according to claim 9, wherein the at least one first trajectory and/or the at least one second trajectory are superimposed on the image data displayed on the image display unit, when the steering angle of the tractor unit has the predetermined amount.

11. The visual system according to claim 8, wherein the mathematical model provides an angle formed between the tractor unit and the trailer as an output.

12. The visual system according to claim 1, wherein at least one predefined point on the vehicle is used as a reference point.

13. The visual system according to claim 12, wherein the at least one predefined point is provided on the rear axis of the vehicle and the rear axis of the tractor, respectively, and/or on the rear axis of the trailer.
